(19) United States
(12) Patent Application Publication
(10) Pub. No.: US 2007/0073034 A1
(43) Pub. Date: Mar. 29, 2007

(54) Pseudo-donor-containing second-order nonlinear optical chromophores with improved stability and electro-optic polymers covalently incorporating the same

(75) Inventor: Chuanguang Wang, Canoga Park, CA (US)

Correspondence Address: HENRICKS SLAVIN AND HOLMES LLP;SUITE 200, 840 APOLLO STREET, EL SEGUNDO, CA, 90245, US

(73) Assignee: Pacific Wave Industries, Inc.

(21) Appl. No.: 11/237,474

(22) Filed: Sep. 28, 2005

(51) Int. Cl. C08G 63/685; C08G 64/42; C08G 69/48

(52) U.S. Cl. 528/322; 525/420; 525/437; 528/298; 528/308

(57) ABSTRACT

Pseudo-donor-containing second-order nonlinear optical chromophores with improved stability and electro-optic polymers covalently incorporating the same are described.

### STATEMENT REGARDING FEDERALLY SPONSORED RESEARCH AND DEVELOPMENT

This invention was made with financial support from the government of the United States of America under Contracts F33615-03-C-5407, F33615-C-5412 awarded by the United States Air Force. The government of the United States of America has certain rights in this invention as provided by these contracts.

### TECHNICAL FIELD

The present invention relates generally to nonlinear optical (NLO) chromophores and, in particular, second-order NLO chromophores containing pseudo-donor, donor, π-conjugate bridge, and acceptor moieties and electro-optic (EO) polymers covalently incorporating the same.

### BACKGROUND ART

Some attempts to address the issue of long-term stability of EO polymers and polymer-based photonic devices have involved covalently incorporating functionalized chromophores into the polymer systems. In such covalently bonded systems (i.e., crosslinking or non-crosslinking polymers), there is always, in principle, a conflict between higher temporal thermal stability and greater EO coefficients. It is thus of considerable importance to control as perfectly as possible the rigidity of the EO polymer backbone without attenuating the poling efficiency and without sacrificing the solubility and processability of polymer films. Unfortunately, it is not an easy undertaking to achieve a realistic trade-off among these properties, especially in the crosslinking system.

### BRIEF DESCRIPTION OF THE DRAWINGS

FIG. 1 illustrates the basic structure of pseudo-donor-containing chromophores according to example embodiments of the present invention;

FIG. 1A illustrates an example embodiment of a pseudo-donor structure for the chromophores of the present invention;

FIG. 1B illustrates example embodiments of chromophore structures according to the present invention;

FIG. 2 illustrates an example synthetic scheme of a pseudo-donor part according to an embodiment of the present invention;

FIG. 3 illustrates an example synthetic scheme of a pseudo-donor-containing chromophore according to an embodiment of the present invention;

FIG. 4 illustrates an example synthetic scheme of an EO polymer with pseudo-donor-embedded structure according to an embodiment of the present invention;

FIG. 5 illustrates an example synthetic scheme of an EO polymer with donor-embedded structure according to an embodiment of the present invention;

FIG. 6 shows the characterization of EO parameters of an example EO polymer with pseudo-donor-embedded structure at different formulations in contrast with donor-embedded structure;

FIG. 7 shows the results of thermogravimetric analysis of an example EO polymer with pseudo-donor-embedded structure at different formulations in contrast with donor-embedded structure;

FIG. 8 illustrates an example Mach Zehnder modulator incorporating a chromophore material of the present invention; and

FIG. 9 illustrates an example use of an EO material of the present invention (in the form of microstrip lines) in a microwave phase shifter of the type employed in optically controlled phased array radars.

### DISCLOSURE OF INVENTION

Example embodiments of the present invention involve a new class of high μβ second-order nonlinear optical (NLO) chromophores containing four moieties, namely, pseudo-donor, donor, π-conjugate bridge, acceptor, and electro optical (EO) polymers convalently incorporating the same. The additional, more rigid aromatic pseudo-donor part is dihydroxyl-functionalized as described herein to anchor the chromophore part into the high-T_{g} polymer matrixes as a side chain. The so-called “side chain” EO polymers realize a better trade-off between temporal thermal stability and electro-optic coefficients (poling efficiency). A mild room temperature (e.g., approximately 25° C.) polymerization method for providing EO polymers that can reach a high polymerization degree with excellent film-forming properties is also described herein.

In an example embodiment of a covalently bonded system, the chromophore includes a donor part, bearing a dihydroxyl group as an attachment point, is wholly introduced into the polymer matrix as a part of the backbone. This structure is referred to as the donor-embedded structure. A consequence of the increased rigidity of this structure is that the thermal stability of covalent systems is far higher than that of the chromophore itself. In other words, the thermal stability of the chromophores is improved greatly by forming the donor-embedded structure.

Embodiments described herein also involve improving the rigidity of chromophore monomer. In contrast with the donor-embedded structure, the pseudo-donor-embedded structure is developed. Compared to its aromatic counterpart, the most common aliphatic donor group of chromophore is still considered to be the weak link of the EO polymer. On the other hand, the donor-embedded structure, to some extent, hinders the mobility of the chromophore and reduces the free volume of the resulting polymer. In this regard, the most direct consequence might be the attenuation of poling efficiency and the order parameter of the chromophore; this is an additional advantage of the pseudo-donor-embedded structure.

According to example embodiments of the present invention, a variety of different molecular structures are possible for the chromophores with pseudo-donor. In an example embodiment, a chromophore includes a dihydroxyl-functionalized aromatically rigid pseudo-donor, an aliphatically linked amino donor, a π-conjugate bridge and an acceptor.

In an example embodiment, a side-chain polymer is synthesized through a chromophore with pseudo-donor dihydroxyl-functionalized, a dicarboxylic acid, and a diphenol. In an example embodiment, the dicarboxylic acid monomer also includes at least one imide unit.

In an example embodiment, a polymer with donor-embedded structure is synthesized through a chromophore with donor group dihydroxyl-functionalized, a dicarboxylic acid, and a diphenol. In an example embodiment, the dicarboxylic acid monomer also includes at least one imide unit.

The NLO materials described herein are suitable for a wide range of devices. Functions performed by these devices include, but are not limited to: electrical to optical signal transduction; radio wave to millimeter wave electro-magnetic radiation (signal) detection; radio wave to millimeter wave signal generation (broadcasting); optical and millimeter wave beam steering; and signal processing such as analog to digital conversion, ultrafast switching of signals at nodes of optical networks, and highly precise phase control of optical and millimeter wave signals. These materials are suitable for arrays which can be used for optically controlled phased array radars and large steerable antenna systems as well as for electro-optical oscillators which can be used at high frequencies with high spectral purity.

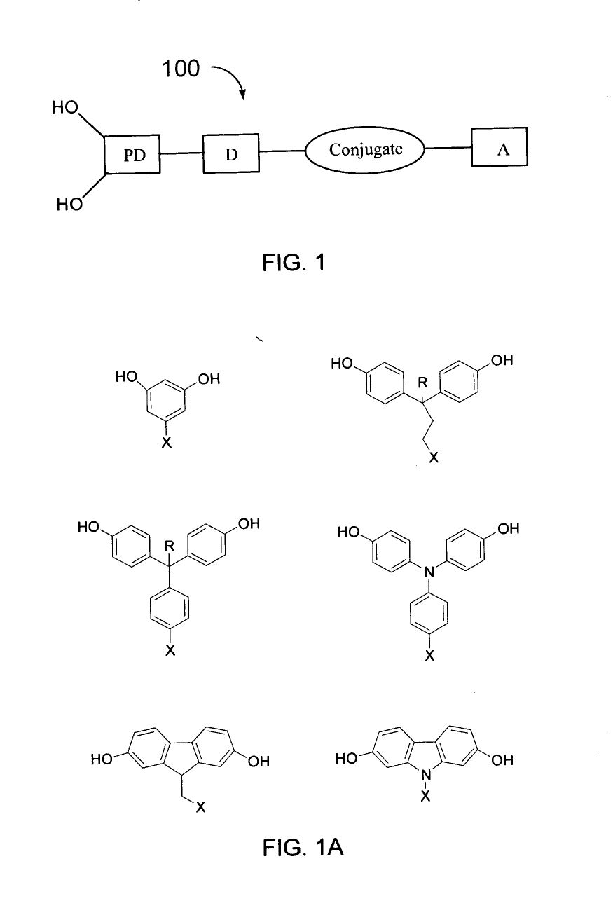

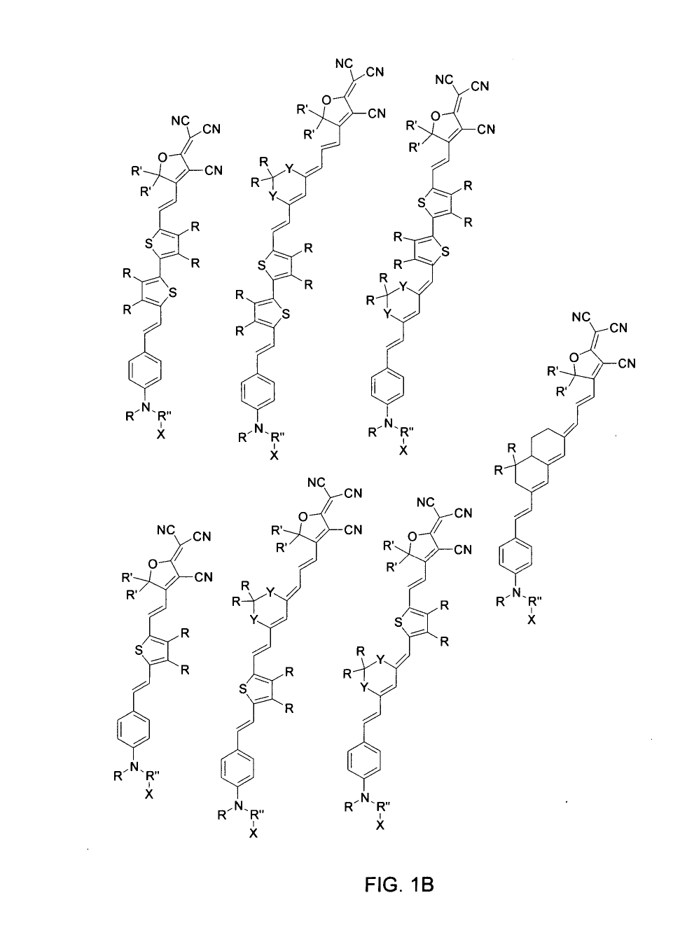

Referring to FIG. 1, the basic chemical structure of a chromophore 100 containing the pseudo-donor group (PD) is shown. In an example embodiment, PD is an aromatically rigid pseudo-donor group, D is an electron-donating group, A is an electron-withdrawing group, and there is π-conjugated bridge between D and A to facilitate the internal charger transfer process of the chromophore. In an example embodiment, the pseudo-donor group is dihydroxyl functionalized to form the polymer backbone.

Referring to FIG. 1A, example embodiments of pseudo-donor structures are shown. In example embodiments, the pseudo-donor group bears a diphenol-type structure. It should also be understood that the pseudo-donor group as described herein is not limited to the structures shown in FIG. 1A. In example embodiments, R=methyl, ethyl or phenyl. In example embodiments, X is selected from COO, O, or H.

Exemplary structures for chromophores including donor, π-conjugated bridge, and acceptor moieties are illustrated in FIG. 1B. In order for the pseudo-donor to connect with the donor part of chromophore, the donor part of chromophore is provided as described herein. According to an example embodiment of the present invention, a donor part of chromophore is mono-hydroxyl functionalized. FIG. 1B illustrates seven example high μβ chromophores suitable for this purpose. It should be understood that their corresponding variations could also be used. In example embodiments, R═H—CₙH₂ₙ₊₁, n=1- 20 including primary, secondary, tertiary, and any branched or cyclic alkyl groups or any alkyl groups with 1-20 carbon atoms functionalized with one or more of the following functional groups: hydroxyl, amino, ether, ester, silyl, siloxyl, etc. In example embodiments, R′ embedded in the tricyano acceptor part can be H—CₙH₂ₙ₊₁, n=1-10 including primary, secondary, tertiary, and any branched or cyclic alkyl groups or any alkyl groups with 1-10 carbon atoms functionalized with one or more of the following functional groups: hydroxyl, amino, ether, ester, silyl, siloxyl, etc. In example embodiments, R′ can be phenyl, or CF₃ also. R and R′ groups at different positions are not necessarily the same, respectively. In example embodiments, R″═H, normal alkyl groups with up to 4 carbon atoms. In example embodiments, Y═O or CH₂.

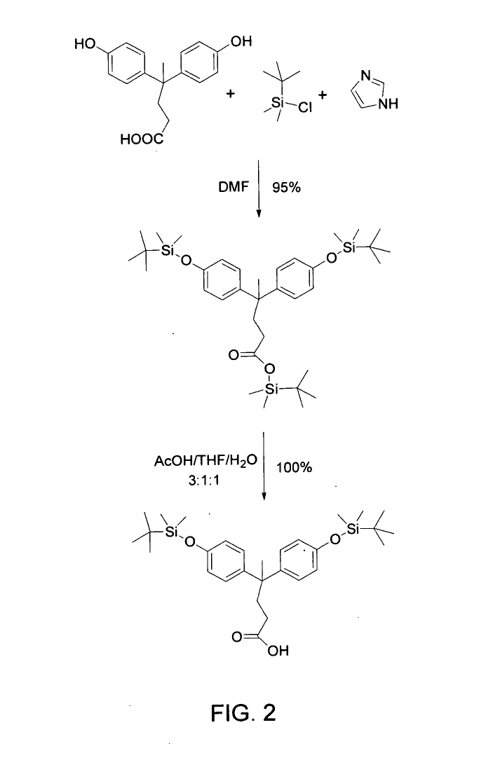

FIG. 2 illustrates an example synthetic scheme for a pseudo-donor structure of the present invention. The detailed procedures are as follows:
4,4-Bis-[4-(tert-butyidimethylsiloxy)-phenyl]-valeric acid tert-butyldimethylsiloxyl ester. A 500-mL Schlenk flask equipped with a magnetic stirring bar and an Ar inlet was charged 4,4-bis(4-hydroxyphenyl)valeric acid (5.7 g, 20 mmol), tert-butyldimethylsilyl chloride (10.8 g, 72 mmol)), imidazole (6.8 g, 100 mmol), and anhydrous DMF (200 mL). After it was flushed with Ar for 30 min, and the reaction mixture was warmed to 50° C. and stirred vigorously overnight to prevent agglomeration. The reaction mixture was an orange solution with white needles on the side of flask. It was diluted with water and extracted with hexanes several times. The organic solutions were combined, washed with brine, and dried over MgSO₄. The volatiles were removed under reduced pressure, yielding a white solid (11.9 g, 95%). ¹H NMR (CDCl₃): δ 7.08 (d, 4H), 6.69 (d, 4H), 2.23 (t, 2H), 1.97 (t, 2H), 1.32 (s, 3H), 0.90 (s, 27H), 0.11 (s, 18H).
4,4-Bis-[4-(tert-butyldimethylsiloxy)-phenyl]-valeric acid. A 1-L round-bottomed flask equipped with a magnetic stirring bar was charged with 4,4-Bis-[4-(tert-butyldimethylsiloxy)-phenyl]-valeric acid tert-butyldimethylsiloxyl ester (11.9 g, 19 mmol). THF (100 mL), glacial acetic acid (300 mL), and distilled water (100 mL) were added sequentially. And the reaction mixture was stirred for 3 h under the air. The reaction mixture was diluted with cold water and cooled to 0° C. in an ice bath, yielding a fine white precipitate which was filtered and dried in vacuo (9.7 g, 100%). ¹H NMR (DMSO-d₆): 12.1 (b, 1H), δ 7.0 (d, 4H), 6.67 (d, 4H), 2.16 (t, 2H), 1.91 (t, 2H), 1.30 (s, 3H), 0.87 (s, 18H), 0.05 (s, 12H).

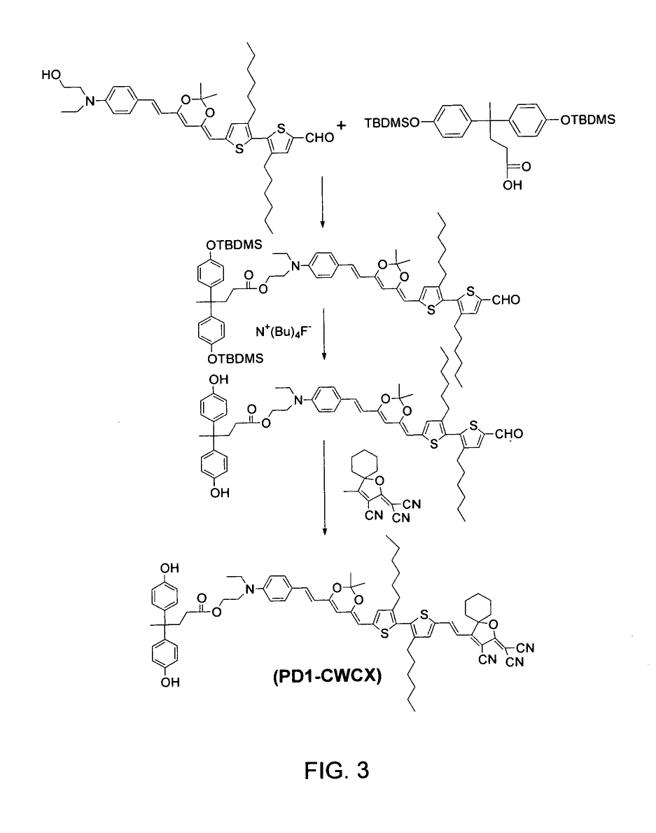

FIG. 3 illustrates a synthetic scheme for an example CWC-series chromophore bearing the pseudo-donor part (PD1-CWCX) of the present invention. The basic structure and synthesis of CWC series are described in U.S. patent application Ser. No. 09/898,625 entitled “Second-Order Nonlinear Optical Chromophores Containing Dioxine and/or Bithiophene as Conjugate Bridge and Devices Incorporating the Same” filed on Jul. 3, 2001, now U.S. Pat. No. 6,555,027 B2, which is incorporated herein by reference. In an example embodiment, PD1-CWCX is synthesized by going further two more steps, starting from mono-hydroxyl CWC-X. Although the coupling step of mono-hydroxyl CWC-X and the pseudo-donor part proceeded well with a yield of ˜85%, the final deprotection step proved to be critical in the process of producing dihydoxyl-functionalized PD1-CWCX. Some chromophores are very sensitive to chemical manipulation, and sometimes even mild conditions still destroy the chromophores. Several weak acid catalysts were tested in the last step. 1N HCl acid used to be employed to deprotect aliphatic-binding hydroxyl group, in the case of CWC-X. However, 1N HCl acid catalyst did not work in the case of PD1-CWCX. A stronger acid catalyst, N⁺(Bu)₄F⁻, was able to disassociate the ether bond of phenyl-O-TBDMS, however, it also decomposed the chromophore by presumably attacking the most sensitive part, namely, the tricyano acceptor. This indicates that the synthetic route of PD1-CWCX could not start simply from CWC-X, and that the birth step of dihydroxyl-functionalized pseudo-donor part should take place ahead of the coupling between the part of pseudo-donor/donor/conjugated bridge and the acceptor apart. The design shown in FIG. 3 embodies the above observance and avoids direct contact between the tricyano acceptor and N⁺(Bu)₄F⁻. The incorporating of the TCF acceptor was deferred until the acid catalyst had been used to cleave the ether binding bonds of the phenyl-O-TBDMS groups. With reference to FIG. 3, the mono-hydroxylized CWC-like aldehyde precursor was first coupled with TBDMS-protected pseudo-donor moiety. Then the newly made intermediate was processed at the catalyst N⁺(Bu)₄F⁻ to produce a dihydroxyl-functionalized precursor, pseudo-donor/donor/conjugate bridge/CHO. Finally, the CHO group was reacted with a TCF acceptor to afford the final target molecule, PD1-CWCX.

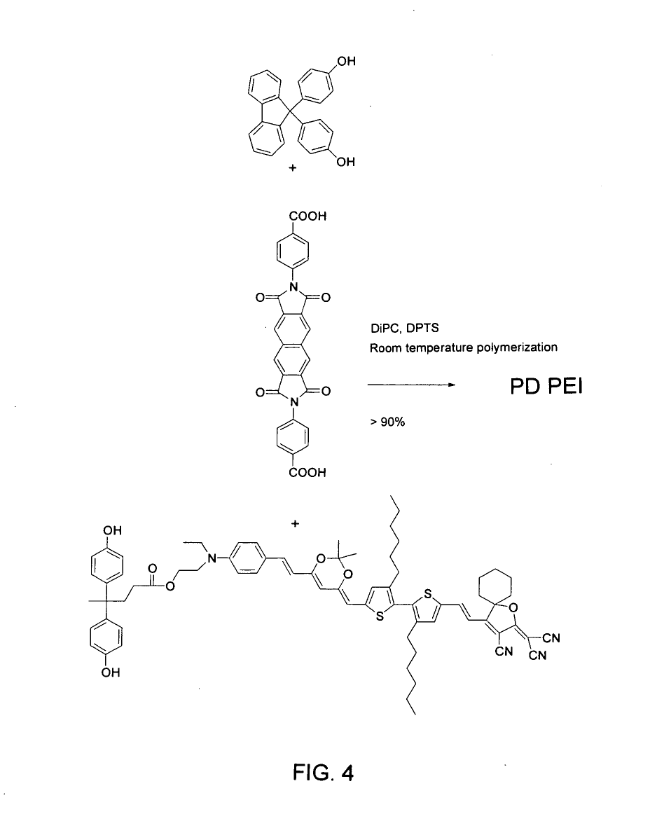

FIG. 4 illustrates an example poly(ester-imide) with pseudo-donor-embedded structure (PD PEI) based on PD1-CWCX according to the present invention. In an example embodiment, poly(ester-imide) is prepared from the condensation reaction of PD1-CWCX, 4,4′-(9-fluorenylidene)-diphenol, and imide-containing aromatic dicarboxylic acid.

Larger EO coefficients and higher long-term stability of EO polymers are two key boosters in the movement towards of the commercialization phase of polymer-based photonic devices. During the practice of pursuing higher EO coefficients, it should be realized that most high μβ chromophores are very sensitive to chemical manipulations and rapidly decompose under even weak acidic or basic conditions. Therefore, few polymerization reactions are compatible with chromophore manipulations.

To provide thermal stability, polyimide or imide moiety can be used. Additionally, aromatic polyimides generally possess exceptional optical properties, low dielectric constants and high resistivities. A relatively high resistivity should be realized in the resulting EO polymer in order to enhance poling efficiency and maximize EO coefficient in the process of translating microscopic optical nonlinearity into macroscopic electro-optic activity. However, the poor solubility of many polyimides in common organic solvents makes it difficult to obtain good optical quality films. Generally, polyimides were once synthesized via standard, two-step condensation polymerization. Poly(amic acid) prepolymers were first synthesized by the reaction of a diamino monomer with a dianhydride monomer, and were spin-coated to form uniform films. The films were then imidized by thermal cyclization at high temperatures during poling. However, a high poling field could not be applied for this film due to the release of small molecules (such as water) in the process of imidization, resulting in dielectric breakdown of the film in most cases. These problems severely hindered the further development of polyimides for practical applications.

Amorphous polycarbonates or polyesters have been widely used as a host polymer to prepare the EO polymeric composites because of their good thermal, mechanical, optical and dielectric properties. Electro-optic polymerization by condensation reactions has several synthetic limitations, which include lack of methodologies for precise control of chain length and few known reactions that take place under extremely mild conditions. These limitations are an obstacle to covalent incorporation of CWC-series chromophores into polymer lattices. A related problem is the general need to convert condensation monomers to an activated derivative prior to condensation. This is also an almost impossible task in case of CWC-series. For the condensation polymerization, the reactivity of monomers is of top importance, especially in the case of CWC-type chromophore monomerwhere one cannot expect to activate the reactivity of monomers involved by increasing the reaction temperature or using harsher acid/base catalysts.

To circumvent the above-mentioned obstacles, a new room temperature polymerization method has been developed for the preparation of high molecular weight polyesters directly from dicarboxylic acids and dihydroxyl-functionalized chromophore monomers. The solution polymerization reaction proceeds under mild conditions, near neutral pH, and also avoids the use of preactived acid derivatives for estification. The dicarboxylic acid monomer is specially designed to introduce the imide moiety with the aim of increasing the resistivity of the resulting polymer and avoiding thermal cyclization during poling.

Referring to FIG. 4, an exemple polymer poly(ester-imide) is prepared from the condensation reaction of PD1-CWCX, 4,4′-(9-fluorenylidene)-diphenol, and imide-containing aromatic dicarboxylic acid. Dicarboxylic acid was specially designed and synthesized via a two-step reaction. Diphenol was used to enhance the rigidity of the polymer backbone and adjust the chromophore loading density. The general procedures for synthesizing poly(ester-imide) are as follows:

The Synthesis of Poly(Ester-Imide):

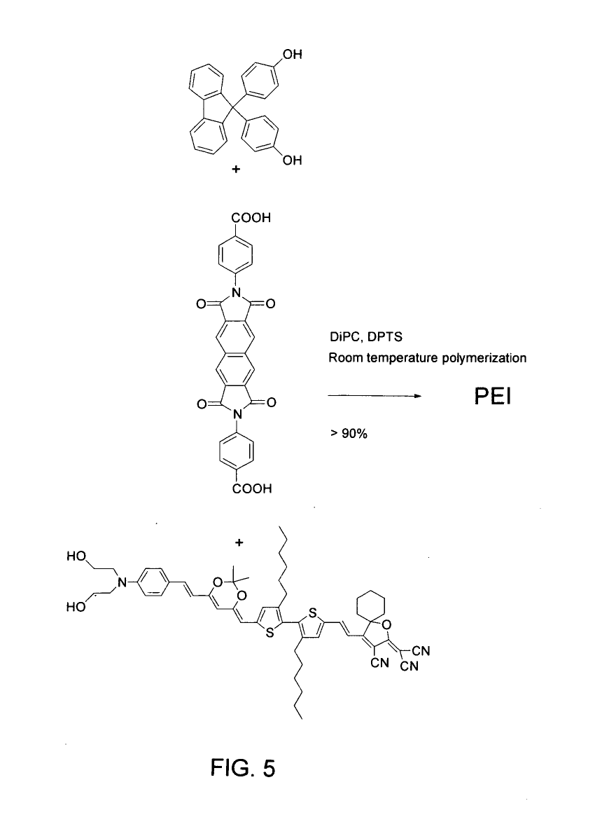

The imide-containing dicarboxylic acid monomer can be pre-prepared by the reaction of dianhydride (for example, 2,3,5,8-naphthalenetetracarboxylic dianhydride) and amino acid (for example, 4-aminobenzoic acid). The conditions required for polymerization include catalysis of 1,3-diisopropylcarbodiimide (DiPC) and 4-(dimethylamino)pyridinium 4-toluenesulfonate (DPTS), which is the 1:1 molecular complex formed by 4-(dimethylamino)pyridine and 4-toluenesulfonic acid. By way of example, 1 equivalent of PD1-CWCX, 1 equivalent of 4,4′-(9-fluorenylidene)-diphenol, 2 equivalents of imide-containing dicarboxylic acid, and 4 equivalents of DPTS were mixed completely into anhydrous DMF under Ar atmosphere, and 10 equivalents of DiPC were added via syringe. Stirring at room temperature under Ar was continued overnight until the polymerization was completed. Then the reaction mixture was poured into vigorously stirred methanol for polymer precipitation. In an example embodiment, the polymer is purified via a repeating step of redissolve-precipitate. In a similar fashion, FIG. 5 illustrates an exemple poly(ester-imide) (PEI) out of normal dihydroxyl-functionalized CWC-X.

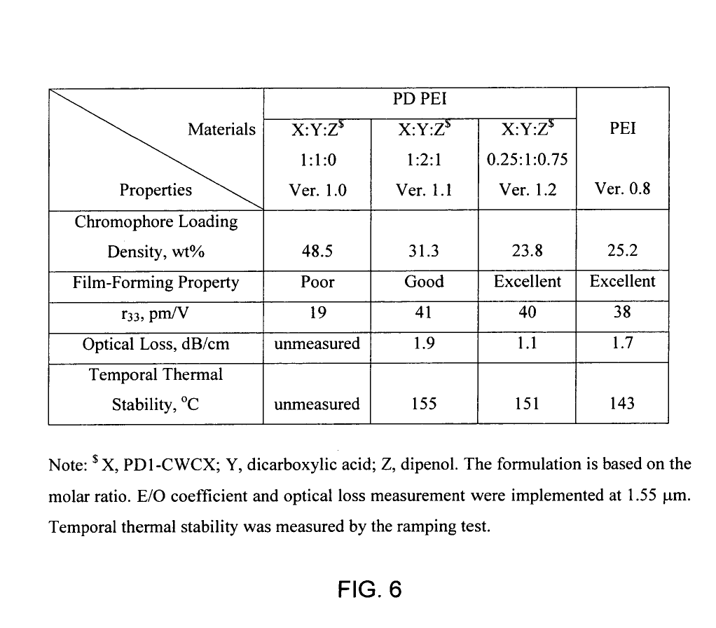

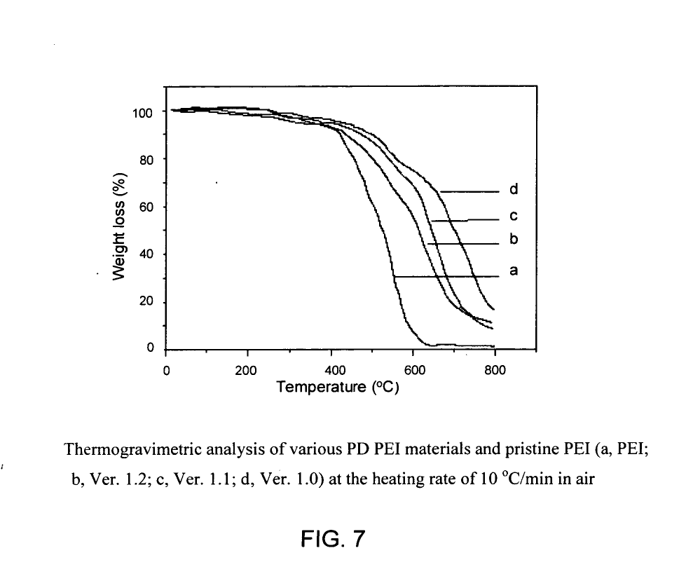

Referring to FIG. 6, PD PEIs with different formulations was investigated and the results were compared against PEI. The introduction of more rigid pseudo-donor moiety into the polymer backbone renders the resulting E-O materials with better thermal stability. Generally, various PD PEI materials enjoy more enhanced thermal stability than original PEI, as evidenced by TGA measurements (see FIG. 7) and ramping tests. With respect to the optimal ratio of different building blocks in the polymer bone, in an example embodiment and referring to FIG. 6, the collected data in the column 2 necessitates the existence of the third co-monomer, say, 4,4′-(9-fluorenylidene)-diphenol. Without the biphenol spacer, such high chromophores loading density would result in poor processibility of polymer films and increase excessive amount of deleterious inter-chromophore interactions. Even at the loading density of 23.8%, some tiny area of “chromophore packing” sometimes can be detected. As a consequence of the universality of room temperature polymerization under the catalyst of DPTS/DiPC, PD1-CWCX has at least the same degree of reactivity with dicarboxylic acid as the CWC-X, so that in the case of loading density of 23.8%, PD BP-3 has as good a film-forming property as BP-3. This good film-forming property is one of the reasons for optical loss as low as ˜1.1 dB/cm.

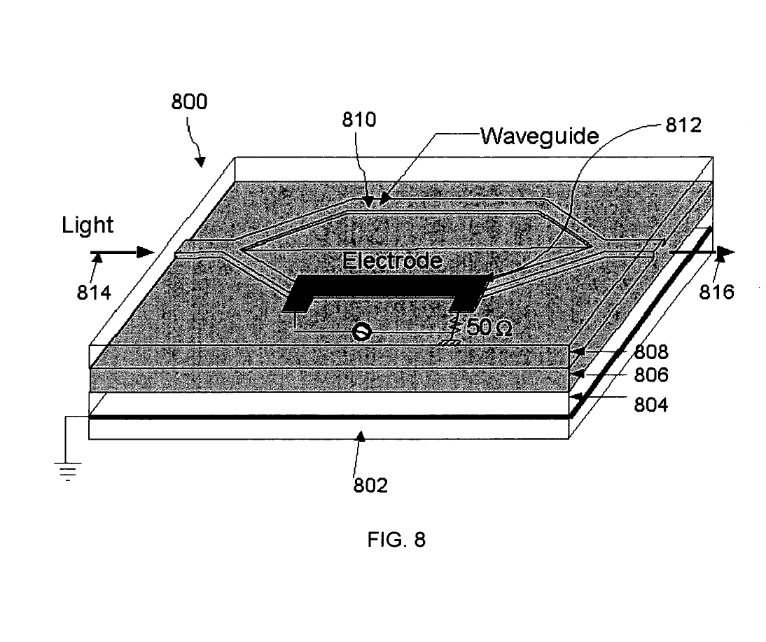

Referring to FIG. 8, an exemplary preferred Mach Zehnder modulator 800 incorporating an EO material of the present invention is illustrated. By way of example, the modulator 800 includes a Si substrate 802, a lower cladding UV-15 layer 804, a PEI or PD PEI layer 806, an upper cladding UFC-170 layer 808, a waveguide 810 and an electrode 812 configured as shown with light indicated by arrows 814, 816.

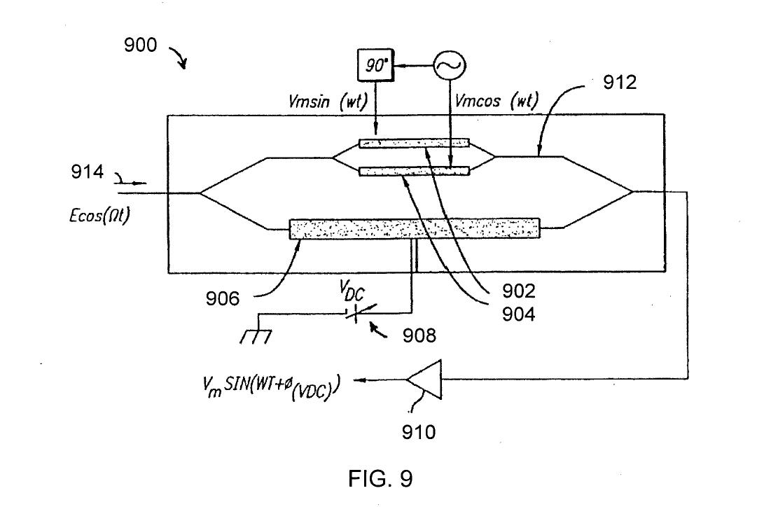

Referring to FIG. 9, the materials of the present invention are shown in the form of microstrip lines in an example embodiment of a microwave phase shifter 900 of the type employed in optically controlled phase array radars. By way of example, the microwave phase shifter 900 includes microstrip lines 902, and 904, a DC control electrode 906, a DC source 908, a photodetector 910, and an optical waveguide 912 configured as shown with light indicated by arrow 914.

Although the present invention has been described in terms of the example embodimentsabove, numerous modifications and/or additions to the above-described embodiments would be readily apparent to one skilled in the art. It is intended that the scope of the present invention extend to all such modifications and/or additions.

What is claimed is:

1. An organic chromophore comprising: 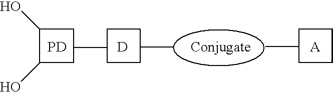
wherein PD is a rigid aromatic pseudo-donor group;
wherein D is an electron donating group;
wherein A is an electron accepting group;
wherein Conjugate is a π-conjugate bridge that connects D and A.

2. The organic chromophore of claim 1, wherein the pseudo-donor part is formed as one of the following structures 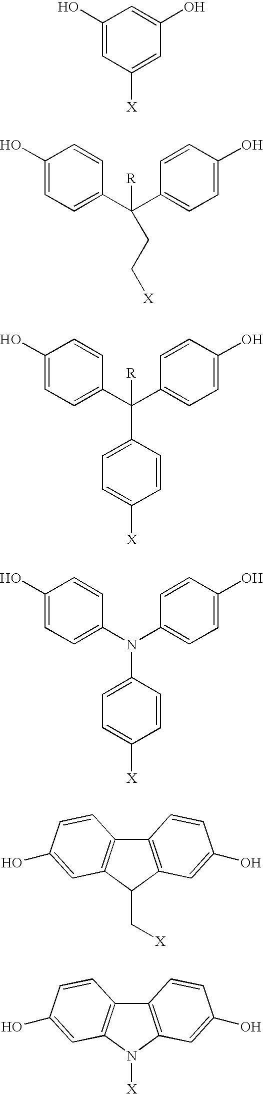
wherein R=methyl, ethyl or phenyl, and X is selected from COO, O, or H.

3. The organic chromophore of claim 1, wherein the D-π-A part is formed as one of the following structures 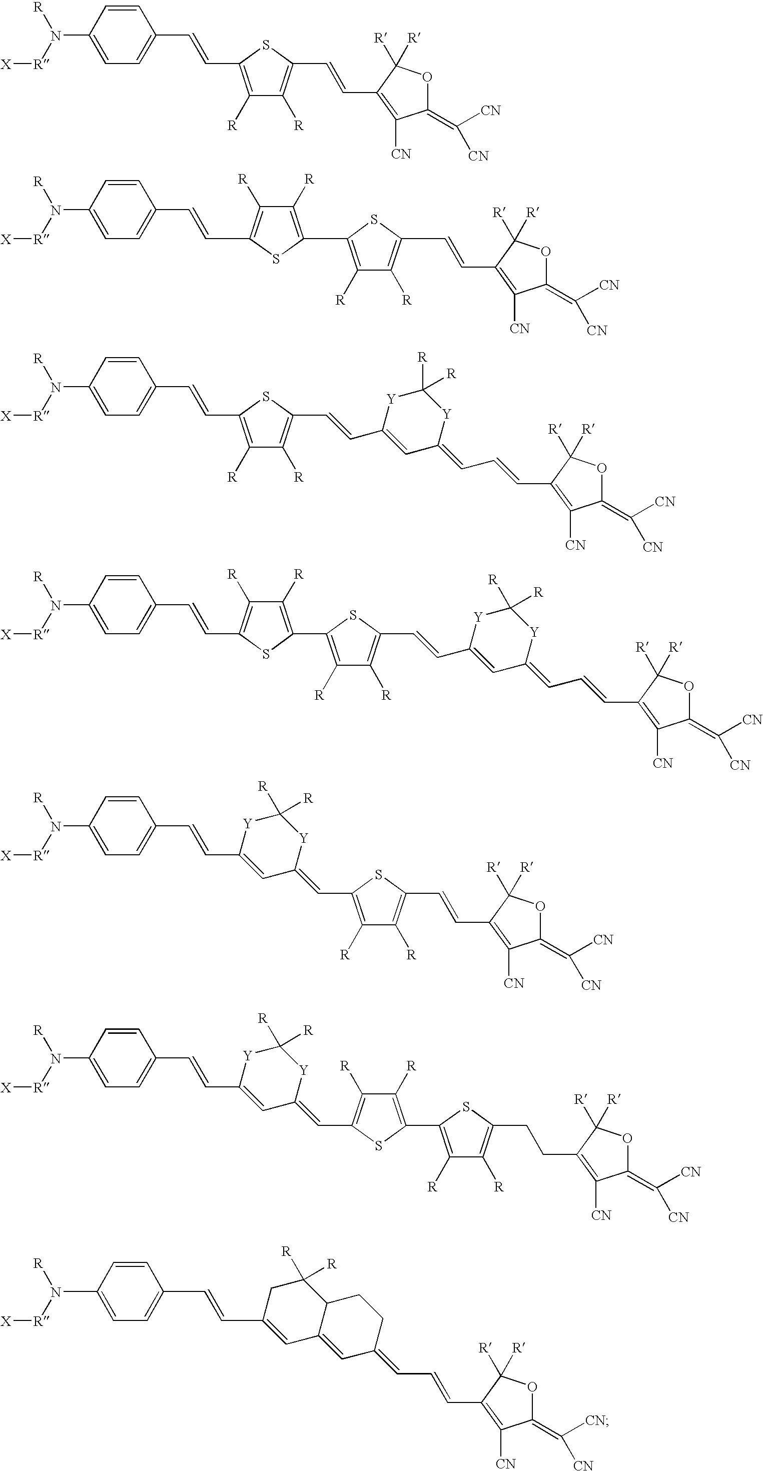
wherein R═H—CₙH₂ₙ₊₁, n=1-20 including primary, secondary, tertiary, and any branched or cyclic alkyl groups or any alkyl groups with 1-20 carbon atoms functionalized with one or more of the following functional groups: hydroxyl, amino, ether, ester, silyl, and siloxyl;
wherein R′ embedded in the tricyano acceptor part is
H—CₙH₂ₙ₊₁, n=1-10 including primary, secondary, tertiary, and any branched or cyclic alkyl groups or any alkyl groups with 1-10 carbon atoms functionalized with one or more of the following functional groups: hydroxyl, amino, ether, ester, silyl, and siloxyl,
Phenyl, or
CF₃;
wherein R and R′ groups at different positions are not necessarily the same;
wherein R″═H, normal alkyl groups with up to 4 carbon atoms;
wherein Y═O or CH₂.

4. A pseudo-donor-containing chromophore formed as

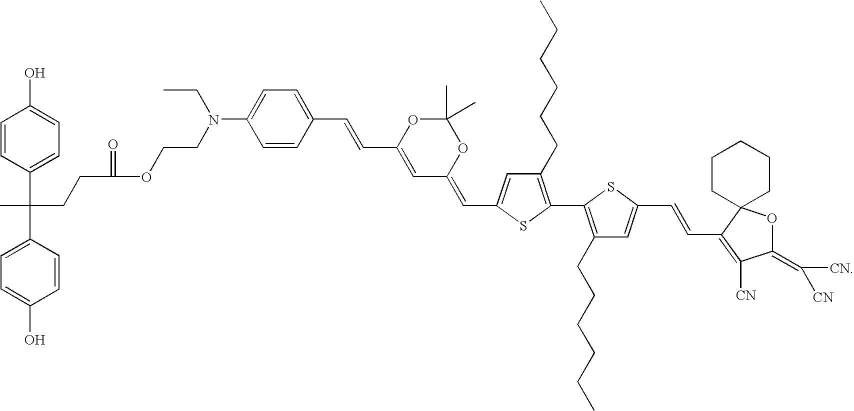

5. An EO polymer poly(ester-imide) with pseudo-donor-embedded structure comprising pseudo-donor-containing chromophore, imide-containing dicarboxylic acid, and diphenol formed according to the following scheme:

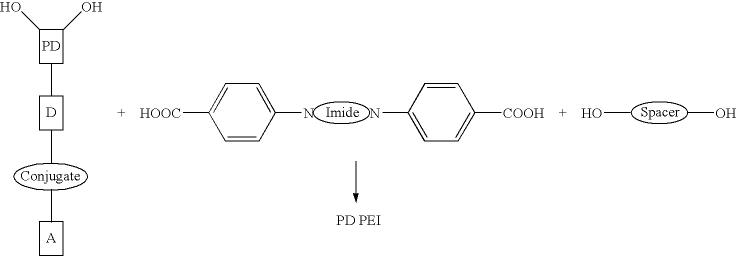

6. An EO polymer poly(ester-imide) with donor-embedded structure comprising dihydroxyl-functionalized chromophore, imide-containing dicarboxylic acid, and diphenol formed according to the following scheme:

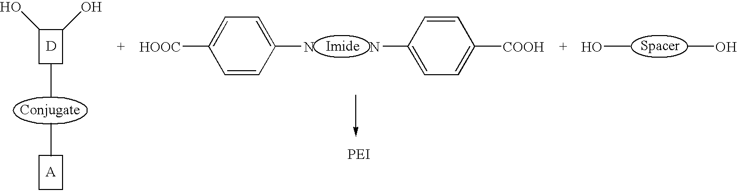

7. A process for synthesizing the polymer of claim 5 or 6 comprising:
providing a mild room temperature polymerization condition; and
performing a catalysis of DPTS and DiPC/DCC.

8. A nonlinear optical device comprising:
an optical modulator formed from an organic chromophore of claim 1 and a polymer of claim 5 or 6.

9. A nonlinear optical device comprising:
a phase shifter formed from an organic chromophore of claim 1 and a polymer of claim 5 or 6.
